(19) United States
(12) Patent Application Publication
(10) Pub. No.: US 2011/0153917 A1
(43) Pub. Date: Jun. 23, 2011

(54) STORAGE APPARATUS AND ITS CONTROL METHOD

(75) Inventors: Tetsuya Maita, Yokohama (JP); Akihiko Sakaguchi, Tachikawa (JP); Tatsundo Aoshima, Yokohama (JP)

(73) Assignee: Hitachi, Ltd.

(21) Appl. No.: 12/703,083

(22) Filed: Feb. 9, 2010

(30) Foreign Application Priority Data
Dec. 17, 2009 (JP) 2009-286814

(51) Int. Cl. G06F 12/00; G06F 12/02; G06F 1/32

(52) U.S. Cl. 711/103; 711/170; 713/324; 711/E12.001; 711/E12.008

(57) ABSTRACT

Proposed are a storage apparatus and its control method capable of performing power saving operations while covering the shortcomings of a flash memory such as the life being short and much time being required for rewriting data. This storage apparatus manages the storage areas provided by each of multiple nonvolatile memories as a pool, provides a virtual volume to a host computer, dynamically allocates the storage area from a virtual pool to the virtual volume according to a data write request from the host computer for writing data into the virtual volume, and places the data in the allocated storage area. In addition, the storage apparatus centralizes the placement destination of data from the host computer to a storage area provided by certain nonvolatile memories and stop the power supply to the nonvolatile memories that are unused, monitors the data rewrite count and/or access frequency to storage areas provided by the nonvolatile memories that are active, migrates data to another storage area if the data rewrite count increases, and distributes the data placement destination if the access frequency becomes excessive.

### CROSS REFERENCES

This application relates to and claims priority from Japanese Patent Application No. 2009-286814, filed on Nov. 17, 2009, the entire disclosure of which is incorporated herein by reference.

### BACKGROUND

The present invention generally relates to a storage apparatus and its control method and, for instance, can be suitably applied to a storage apparatus equipped with a flash memory as its storage medium.

A storage apparatus comprising a flash memory as its storage medium is superior in terms of power saving and access time in comparison to a storage apparatus comprising numerous small disk drives. Nevertheless, a flash memory entails a problem in that much time is required for rewriting since the rewriting of data requires the following procedures.

(Step 1) Saving data of a valid area (area storing data that is currently being used).
(Step 2) Erasing data of an invalid area (area storing data that is not currently being used).
(Step 3) Writing new data in an unused area (area from which data was erased).

In addition, a flash memory has a limited data erase count, and a storage area with an increased erase count becomes unavailable. In order to deal with this problem, Japanese Patent Laid-Open Publication No. 2007-265365 (Patent Document 1) discloses a method of leveling the erase count across a plurality of flash memories (this is hereinafter referred to as the “erase count leveling method”). The erase count leveling method is executed according to the following procedures.

(Step 1) Defining a web leveling group (WDEV) containing a plurality of flash memories (PDEV).
(Step 2) Collectively mapping the logical page addresses of a plurality of PDEVs in the WDEV to a virtual page address.
(Step 3) Combining a plurality of WDEVs to configure a RAID (Redundant Arrays of Independent Disks) group (redundant group).
(Step 4) Configuring a logical volume by combining areas in a single RAID group, or with a plurality of RAID groups.
(Step 5) The storage controller executing the erase count leveling by managing, through figures, the total write capacity per prescribed area in a logical page address space, and moving data between logical page addresses and changing the mapping of the logical-to-virtual page address.

### SUMMARY

However, in order to level the erase count across a plurality of flash memories based on the foregoing erase count leveling method, the flash memories must constantly be active and, consequently, there is a problem in that the power consumption cannot be reduced. In addition, based on the foregoing erase count leveling method, much time is required for rewriting the data, and there is a problem in that the I/O performance of the storage apparatus will deteriorate during that time.

The present invention was devised in view of the foregoing points. Thus, an object of the present invention is to propose a storage apparatus and its control method capable of performing power saving operations while covering the shortcomings of a flash memory such as the life being short and much time being required for rewriting data.

In order to achieve the foregoing object, the present invention provides a computer system comprising a storage apparatus for providing a storage area to be used by a host computer for reading and writing data, and a management apparatus for managing the storage apparatus. The storage apparatus includes a plurality of nonvolatile memories for providing the storage area, and a controller for controlling the reading and writing of data of the host computer from and to the nonvolatile memory. The controller collectively manages the storage areas provided by each of the plurality of nonvolatile memories as a pool, provides a virtual volume to the host computer, dynamically allocates the storage area from the virtual pool to the virtual volume according to a data write request from the host computer for writing data into the virtual volume, and places the data in the allocated storage area. The management apparatus controls the storage apparatus so as to centralize the placement destination of data from the host computer to a storage area provided by certain nonvolatile memories and stop the power supply to the nonvolatile memories that are unused, monitors the data rewrite count and/or access frequency to storage areas provided by the nonvolatile memories that are active, and controls the storage apparatus so as to migrate data to storage areas with a low data rewrite count provided by the other nonvolatile memories if the rewrite count of data in storage areas provided by certain nonvolatile memories increases, and controls the storage apparatus so as to distribute the data placement destination by starting up the nonvolatile memories to which power supply was stopped if the access frequency to storage areas provided by certain nonvolatile memories becomes excessive.

The present invention additionally provides a method of controlling a storage apparatus including a plurality of nonvolatile memories for providing a storage area to be used by a host computer for reading and writing data, wherein the storage apparatus collectively manages the storage areas provided by each of the plurality of nonvolatile memories as a pool, provides a virtual volume to the host computer, dynamically allocates the storage area from the virtual pool to the virtual volume according to a data write request from the host computer for writing data into the virtual volume, and places the data in the allocated storage area. This method comprises a first step of controlling the storage apparatus so as to centralize the placement destination of data from the host computer to a storage area provided by certain nonvolatile memories and stop the power supply to the nonvolatile memories that are unused, a second step of monitoring the data rewrite count and/or access frequency to storage areas provided by the nonvolatile memories that are active, and a third step of controlling the storage apparatus so as to migrate data to storage areas with a low data rewrite count provided by the other nonvolatile memories if the rewrite count of data in storage areas provided by certain nonvolatile memories increases, and controlling the storage apparatus so as to distribute the data placement destination by starting up the nonvolatile memories to which power supply was stopped if the access frequency to storage areas provided by certain nonvolatile memories becomes excessive.

According to the present invention, it is possible to realize a storage apparatus and its control method capable of performing power saving operations while covering the shortcomings of a flash memory such as the life being short and much time being required for rewriting data.

### DESCRIPTION OF DRAWINGS

FIG. 1 is a block diagram showing the overall configuration of a computer system according to an embodiment of the present invention;

FIG. 2 is a block diagram showing the schematic configuration of a flash memory module;

FIG. 3 is a conceptual diagram explaining a flash memory chip;

FIG. 4 is a conceptual diagram explaining the outline of managing storage areas in a storage apparatus;

FIG. 5 is a conceptual diagram explaining a data placement destination management function according to an embodiment of the present invention;

FIG. 6 is a conceptual diagram explaining a data placement destination management function according to an embodiment of the present invention;

FIG. 7 is a block diagram explaining the various control programs and various management tables stored in a memory of a management server;

FIG. 8 is a conceptual diagram explaining a RAID group management table;

FIG. 9 is a conceptual diagram explaining a logical device management table;

FIG. 10 is a conceptual diagram explaining a schedule management table;

FIG. 11 is a conceptual diagram explaining a virtual pool operational information management table;

FIG. 12 is a flowchart showing the processing routine of logical device information collection processing;

FIG. 13 is a flowchart showing the processing routine of data placement destination management processing;

FIG. 14 is a flowchart showing the processing routine of data placement destination distribution processing;

FIG. 15 is a flowchart showing the processing routine of data placement destination centralization processing;

FIG. 16 is a flowchart showing the processing routine of schedule processing;

FIG. 17 is a flowchart showing the processing routine of new virtual pool registration processing;

FIG. 18 is a flowchart showing the processing routine of table update processing;

FIG. 19 is a flowchart showing the processing routine of report output processing; and

FIG. 20 is a schematic diagram showing a configuration example of a report screen.

### DETAILED DESCRIPTION

An embodiment of the present invention is now explained in detail with reference to the attached drawings.

### (1) Configuration of Computer System of this Embodiment

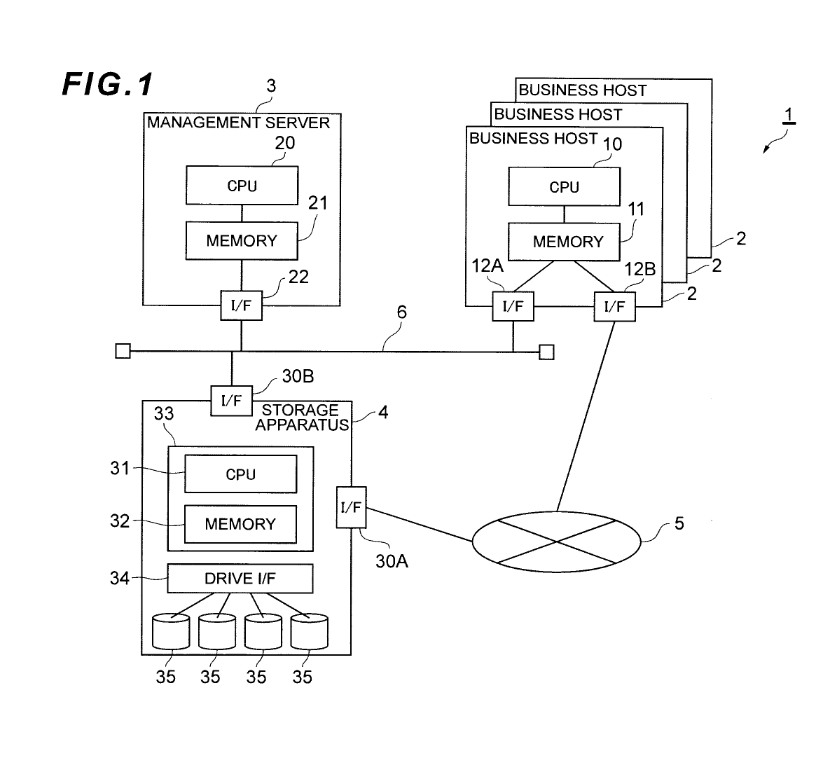

FIG. 1 shows the overall computer system 1 according to this embodiment. The computer system 1 comprises a plurality of business hosts 2, a management server 3 and a storage apparatus 4. Each business host 2 is coupled to the storage apparatus 4 via a network 5, and additionally coupled to the management server 3 via a management network 6. The management server 3 is coupled to the storage apparatus 4 via the management network 6.

The network 5 is configured, for instance, from a SAN (Storage Area Network) or Internet. Communication between the business host 2 and the storage apparatus 4 via the network 5 is conducted according to a fibre channel protocol. The management network 6 is configured from a LAN (Local Area Network) or the like. Communication between the management server 3 and the business host 2 or the storage apparatus 4 via the management network 6 is conducted according to a TCP/IP (Transmission Control Protocol/Internet Protocol) protocol.

The business host 2 is a computer device comprising a CPU (Central Processing Unit) 10, a memory 11 and a plurality of interfaces 12A, 12B, and is configured from a personal computer, a workstation, a mainframe computer or the like. The memory 11 of the business host 2 stores application software according to the business content of the user to use the business host 2, and processing according to such user's business content is executed by the overall business host 2 as a result of the CPU 10 executing the application software. Data to be used by the CPU 10 upon executing the processing according to the user's business content is read from and written into the storage apparatus 4 via the network 5.

The management server 3 is a server device comprising a CPU 20, a memory 21 and an interface 22, and is coupled to the management network 6 via the interface 22. As described later, the memory 21 of the management server 3 stores various control programs and various management tables, and the data placement destination management processing described later is executed by the overall management server 3 as a result of the CPU 20 executing the foregoing control programs.

The storage apparatus 4 comprises a plurality of network interfaces 30A, 30B, a controller 33 including a CPU 31 and a memory 32, a drive interface 34, and a plurality of flash memory modules 35.

The network interface 30A is an interface that is used by the storage apparatus 4 for sending and receiving data to and from the business host 2 via the network 5, and executes processing such as protocol conversion during the communication between the storage apparatus 4 and the business host 2. In addition, the network interface 30B is an interface that is used by the storage apparatus 4 for communicating with the management server 3 via the management network 6, and executes processing such as protocol conversion during the communication between the storage apparatus 4 and the management server 3. The drive interface 34 functions as an interface with the flash memory module 35.

The memory 32 of the controller 33 is used by the business host 2 for temporarily storing data to be read from and written into the flash memory module 35, and also used as a work memory of the CPU 31. Various control programs are also retained in the memory 32. The CPU 31 is a processor that governs the operational control of the overall storage apparatus 4, and reads and writes data of the business host from and to the flash memory module 35 by executing the various control programs stored in the memory 32.

The drive interface 34 is an interface for performing protocol conversion and the like with the flash memory module 35. The power source control (ON/OFF of the power source) of the flash memory module 35 described later is also performed by the drive interface 34.

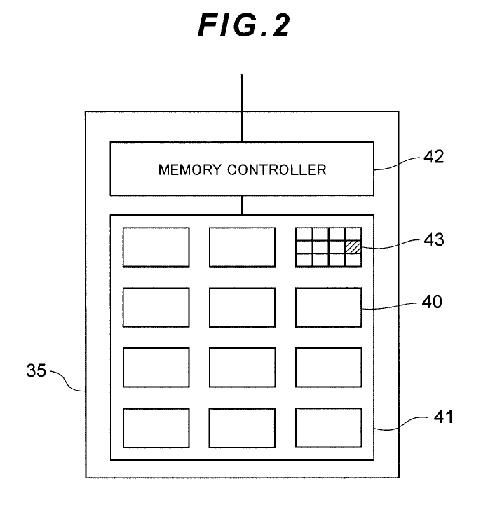

As shown in FIG. 2, the flash memory module 35 comprises a flash memory 41 configured from a plurality of flash memory chips 40, and a memory controller 42 for controlling the reading and writing of data from and to the flash memory 41.

The flash memory chip 40 is configured from a plurality of unit capacity storage areas (these are hereinafter referred to as the “blocks”) 43. The block 43 is a unit for the memory controller 42 to erase data. In addition, the block 43 includes a plurality of pages as described later. A page is a unit for the memory controller 42 to read and write data. A page is classified as a valid page, an invalid page or an unused page. A valid page is a page storing valid data, and an invalid page is a page storing invalid data. An unused page is a page not storing data.

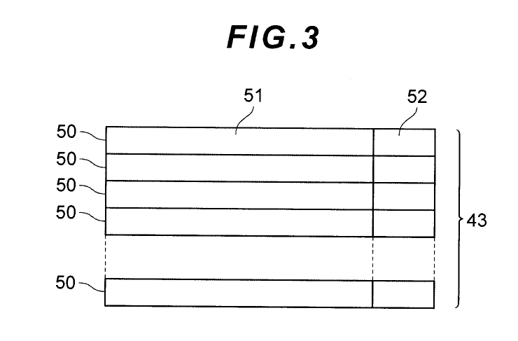

FIG. 3 shows the block configuration in a single flash memory chip 40. The block 43 is generally configured from several dozen (for instance 32 or 64) pages 50. The page 53 is a unit for the memory controller 42 to read and write data and is configured, for instance, from a 512-byte data part 51 and a 16-byte redundant part 52.

The data part 51 usually stores data, and the redundant part 52 stores the page management information and error correction information of such data. The page management information includes an offset address and a page status. The offset address is a relative address in the block 43 to which that page 50 belongs. The page status is information showing whether the page 50 is a valid page, an invalid page, an unused page or a page in processing. The error correction information is information for detecting or correcting an error of the page 50 and, for instance, a hamming code is used.

### (2) Various Functions Loaded in Storage Apparatus

The various functions loaded in the storage apparatus 4 are now explained. In line with this, the method of managing the storage areas in the storage apparatus 4 is foremost explained.

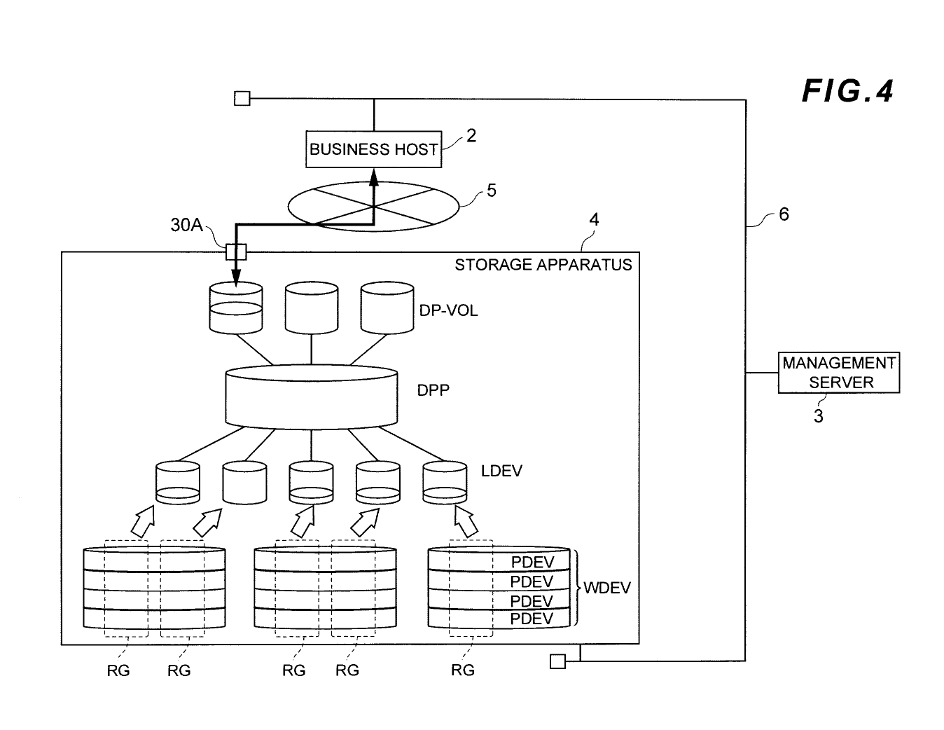

FIG. 4 shows the outline of the method of managing the storage areas in the storage apparatus 4. As shown in FIG. 4, in the storage apparatus 4, one flash memory module 35 is managed as one physical device PDEV, and one web leveling group WDEV is defined by a plurality of physical devices PDEV.

In addition, one or more RAID groups RG are configured from storage areas provided by the respective physical devices PDEV configuring one web leveling group WDEV, and the storage area that is allocated from one RAID group RG (that is, a partial storage area of one RAID group RG) is defined as the logical device LDEV. Moreover, a plurality of logical devices LDEV are taken together to define one virtual pool DPP, and one or more virtual volumes DP-VOL are associated with the virtual pool DPP. The storage apparatus 4 provides the virtual volume DP-VOL as the storage area to the business host 2.

If data is written from the business host 2 into the virtual volume DP-VOL, a storage area of one of the logical devices LDEV is allocated from the virtual pool DPP to a data write destination area in the virtual volume DP-VOL, and data is written into the foregoing storage area.

In the foregoing case, the logical device LDEV to allocate the storage area to the data write destination area is selected at random. Thus, if there are a plurality of logical devices LDEV, data is distributed and stored in such plurality of logical devices LDEV.

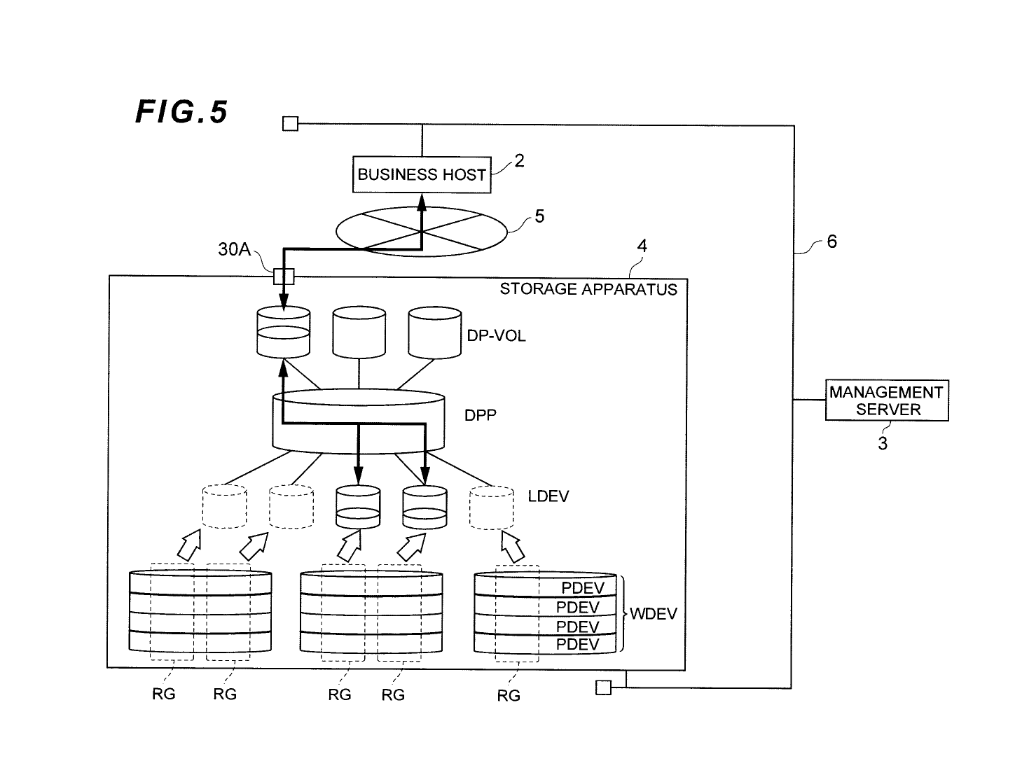

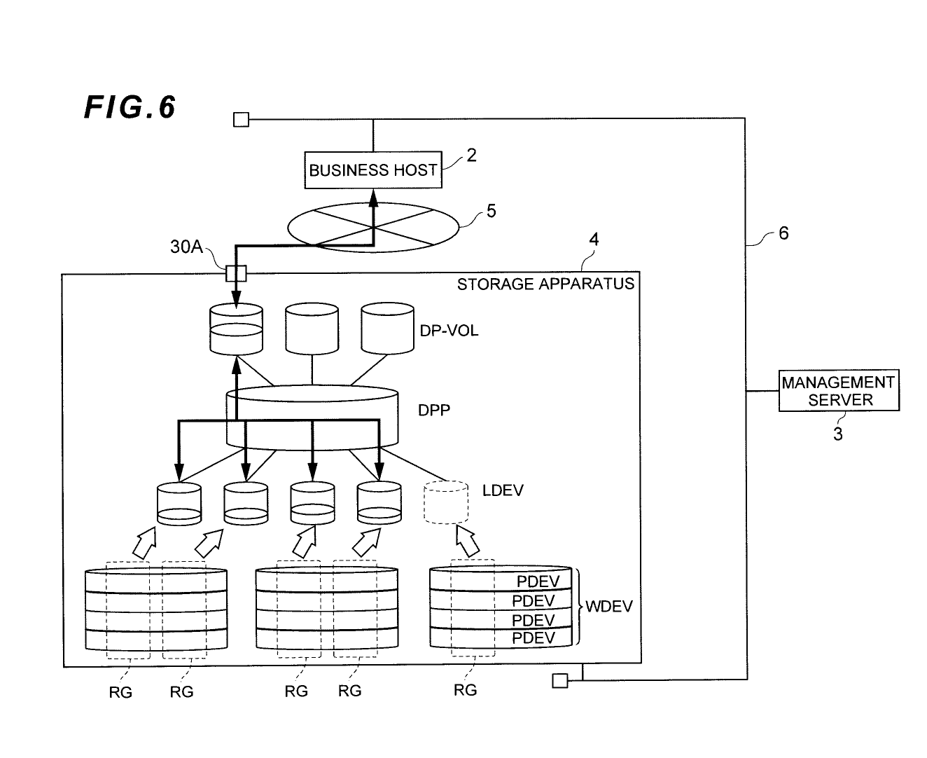

Therefore, in the case of this embodiment, the storage apparatus 4 is loaded with a data placement destination management function for maximizing the number of unused physical devices PDEV (flash memory modules 35) by centralizing the data placement destination to certain logical devices LDEV during normal times and stopping (OFF) the power supply of such unused physical devices PDEV as shown in FIG. 5 on the one hand and, if there is an increase in the data write count or access frequency to the logical devices LDEV that are active, as shown in FIG. 6, migrating data stored in a logical device LDEV with an increased data rewrite count to a logical device LDEV with a low data rewrite count, and distributing data stored in a logical device LDEV with excessive access frequency to other logical devices LDEV.

Consequently, the storage apparatus 4 is able to suitably change the data placement destination based on the data placement destination management function, and thereby perform power saving operations during normal times while leveling the life of the flash memory 41 included in the flash memory module 35.

The storage apparatus 4 is also loaded with a schedule processing function for executing processing of distributing data to a plurality of logical devices LDEV during the period from a start time to an end time of a schedule set by the user, and centralizing data to certain logical devices LDEV once again after the lapse of the end time.

Consequently, based on the schedule processing function, the storage apparatus 4 is able to prevent deterioration in the I/O performance by distributing data to a plurality of logical devices LDEV during a period when it is known in advance that access will increase, and perform power saving operations by centralizing the data to certain logical devices LDEV once again after the lapse of the foregoing period.

The storage apparatus 4 is additionally loaded with a virtual pool operational status reporting function for reporting the operational status of the virtual pool DPP. Based on the virtual pool operational status reporting function, the storage apparatus 4 allows the user to easily recognize the operational status of the virtual pool DPP in the storage apparatus 4.

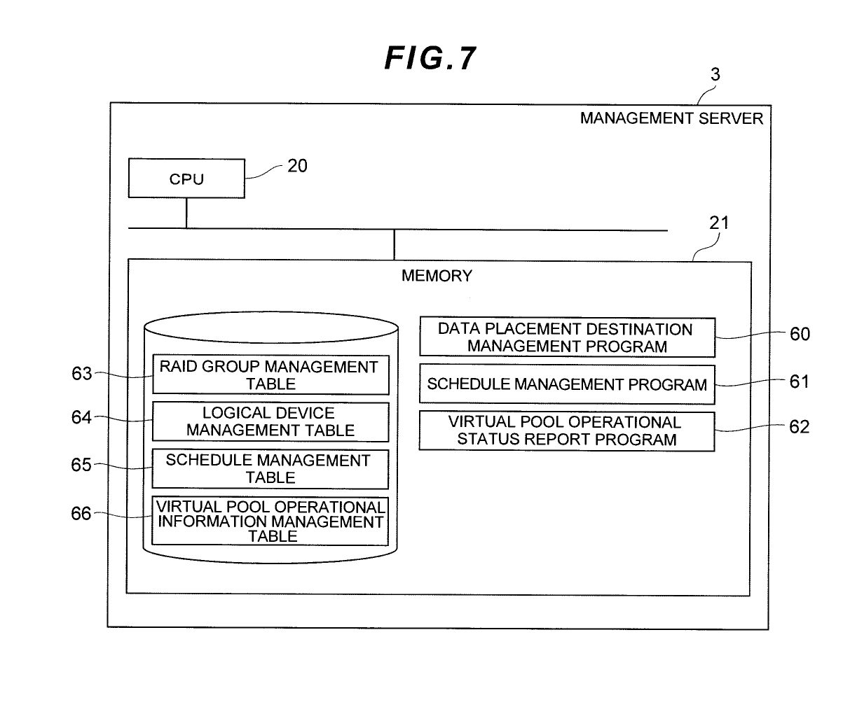

As means for executing the foregoing data placement destination management function, schedule processing function and virtual pool operational status reporting function, as shown in FIG. 7, the memory 21 of the management server 3 stores a data placement destination management program 60, a schedule management program 61 and a virtual pool operational status report program 62, as well as a RAID group management table 63, a logical device management table 64, a schedule management table 65 and a virtual pool operational information management table 66.

The data placement destination management program 60 is a program for executing, in order to realize the foregoing data placement destination management function, data placement destination centralization processing for centralizing data that is distributed and stored in a plurality of logical devices LDEV to certain logical devices LDEV, and data placement destination distribution processing for distributing data that is centralized and stored in certain logical devices LDEV to a plurality of logical devices LDEV.

The schedule management program 61 is a program for executing, in order to realize the foregoing schedule processing function, the foregoing data placement destination distribution processing during the period that is scheduled by the user in advance, and executing the foregoing data placement destination centralization processing after the lapse of such period.

The virtual pool operational status report program 62 is a program for suitably updating, in order to realize the foregoing virtual pool operational status reporting function, the virtual pool operational information management table 66, and outputting a report on the operational status of the virtual pool DPP based on the virtual pool operational information management table 66 in accordance with a user command or periodically.

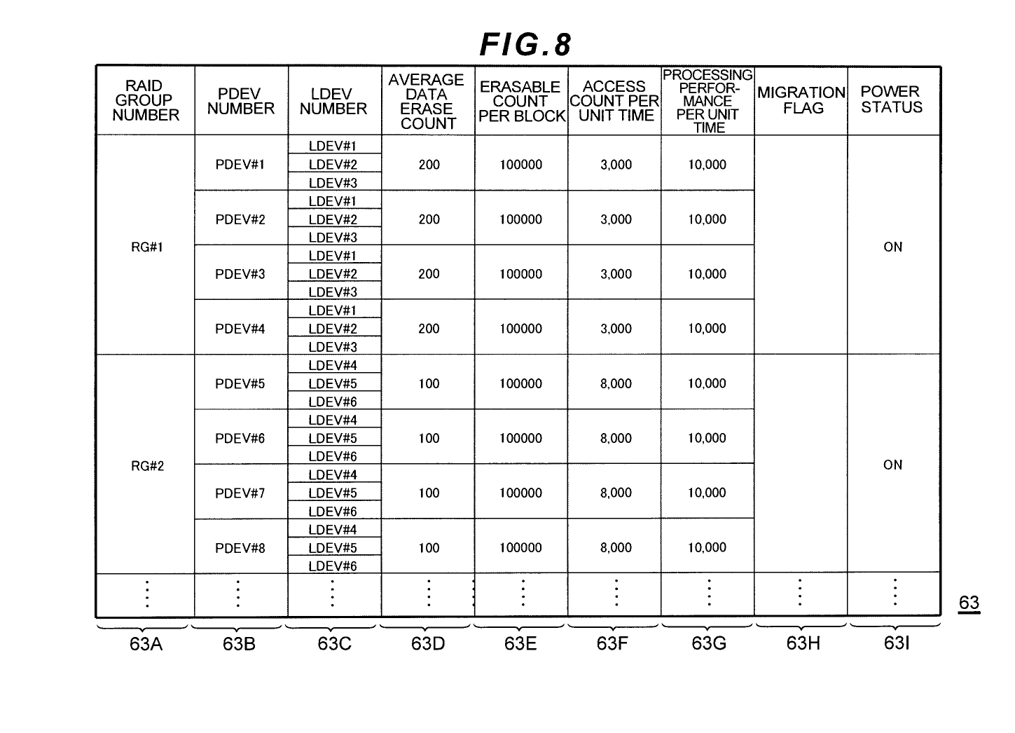

Meanwhile, the RAID group management table 63 is a table for managing the RAID groups RG defined in the storage apparatus 4 and is configured, as shown in FIG. 8, from a RAID group number column 63A, a physical device number column 63B, a logical device number column 63C, an average data erase count column 63D, an erasable count column 63E, an IOPS column 63F, a processing performance column 63G, a migration flag column 63H and a power status column 63I.

The RAID group number column 63A stores the identification number (RAID group number) that is assigned to each RAID group RG defined in the storage apparatus 4, and the physical device number column 63B stores the identification number (physical device number) assigned to each flash memory module 35 (FIG. 1) configuring the corresponding RAID group RG. The logical device number column 63C stores the identification number (logical device number) assigned to each logical device LDEV allocated from that RAID group RG.

The average data erase count column 63D stores the average value of the erase count of data in each block 43 (FIG. 2) in the corresponding flash memory module 35, and the erasable count column 63E stores the maximum value of the erasable count of data in the block 43 in that flash memory module 35. The IOPS column 63F stores the I/O count (IOPS) per unit time to the corresponding flash memory module 35, and the processing performance column 63G stores the processible count of the I/O processing per unit time in that flash memory module 35. The numerical values stored in the erasable count column 63E and the processing performance column 63G are values of the spec of each flash memory chip 40 (FIG. 2) configuring the corresponding flash memory module 35.

The migration flag column 63H stores a flag concerning data migration (this is hereinafter referred to as the “migration flag”). Specifically, the migration flag column 63H stores a migration flag respectively representing “migration source” if data stored in a logical device LDEV allocated from the corresponding RAID group RG is to be migrated to a logical device LDEV allocated from another RAID group RG, “migration destination” if data stored in a logical device LDEV allocated from the other RAID group RG is to be migrated to a logical device LDEV allocated from the corresponding RAID group RG, and “initial value” in all other cases.

The power status column 63I stores the power status of each flash memory module 35 configuring the corresponding RAID group RG. For example, “ON” is stored as the power status if the power source of each flash memory module 35 is being supplied, and “OFF” is stored as the power status if the power supply of each flash memory module 35 is being stopped.

Accordingly, the case of the example shown in FIG. 8 shows that the storage apparatus 4 contains the RAID groups RG indicated as “RG#1” and “RG#2,” among which the RAID group RG indicated as “RG#1” is configured from the four flash memory modules 35 of “PDEV#1” to “PDEV#4,” and the three logical devices LDEV of “LDEV#1” to “LDEV#3” are allocated from the flash memory module 35 indicated as “PDEV#1.” For instance, with the flash memory module 35 indicated as “PDEV#1,” the average value of the erase count of data in each block 43 is “200,” the erasable count per block is “100000,” the access count per unit time is “3000,” and the processing performance per unit time is “10000,” respectively, and the power source of these flash memory modules 35 is ON.

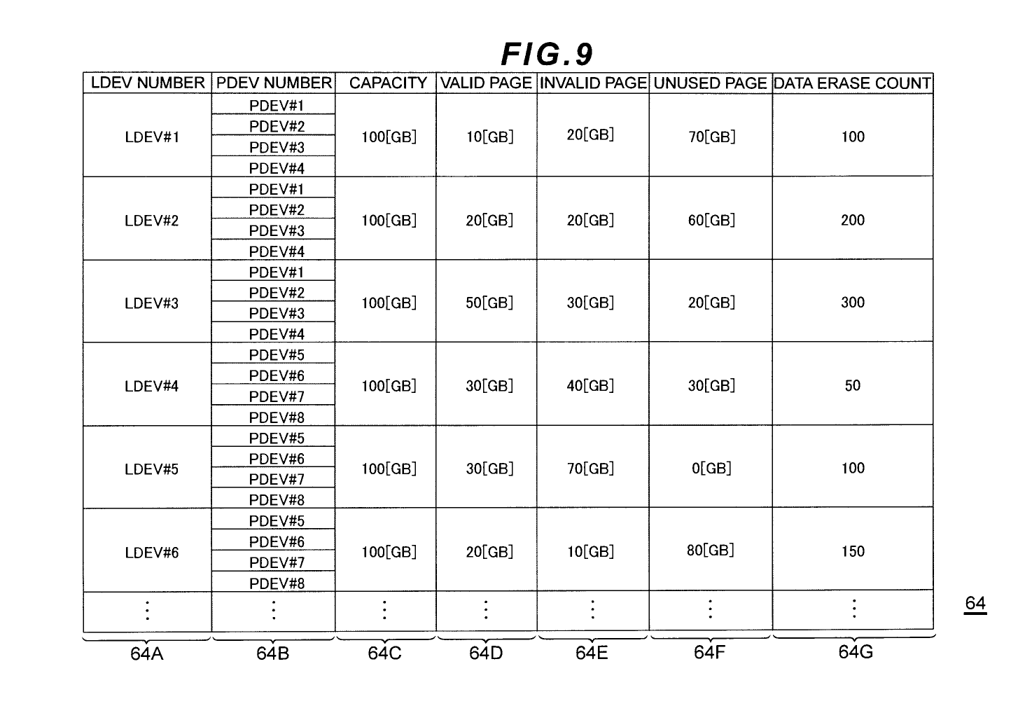

The logical device management table 64 is a table for managing the logical devices LDEV configuring the virtual pool DPP, and is created for each virtual pool DPP. The logical device management table 64 is configured, as shown in FIG. 9, from a logical device number column 64A, a physical device number column 64B, a capacity column 64C, a valid page column 64D, an invalid page column 64E, an unused page column 64F and a data erase count column 64G.

The logical device number column 64A stores the logical device number of each logical device LDEV configuring the corresponding virtual pool DPP, and the physical device number column 64B stores the physical device number of all flash memory modules 35 configuring the corresponding logical device LDEV.

The capacity column 64C stores the capacity of the corresponding logical device LDEV, and the valid page column 64D, the invalid page column 64E and the unused page column 64F respectively store the total capacity of the valid page (valid area), the total capacity of the invalid page (invalid area), and the total capacity of the unused page (unused area) in the corresponding logical device LDEV. The data erase count column 64G stores the number of times that the data stored in the corresponding logical device LDEV was erased.

Accordingly, the case of the example shown in FIG. 9 shows that the logical device LDEV indicated as “LDEV#1” is defined across the storage areas provided by the four physical devices (flash memory module 35) of “PDEV#1” to “PDEV#4,” its capacity is “100[GB],” the total capacity of the valid page is “10[GB],” the total capacity of the invalid page is “20[GB],” the total capacity of the unused page is “70[GB],” and the erase count of current data is “100.”

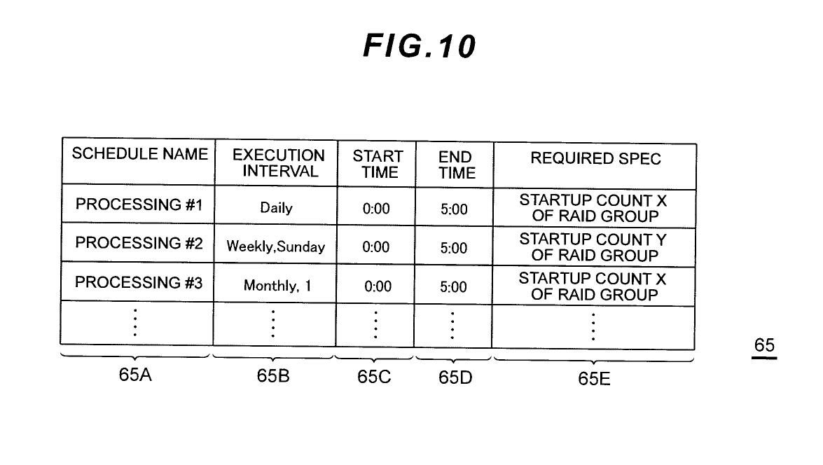

The schedule management table 65 is a table that is used in performing the data placement destination management processing as a result of registering processing in which performance is required, such as batch processing, as a schedule and is configured, as shown in FIG. 10, from a schedule name column 65A, an execution interval column 65B, a start time column 65C, an end time column 65D and a required spec column 65E.

The schedule name column 65A stores the schedule name of the schedule that was registered by the user, and the execution interval column 65B stores the interval in which such schedule is to be executed. The start time column 65C and the end time column 65D respectively store the start time and the end time of the schedule registered by the user, and the required spec column 65E stores the number of RAID groups RG (hereinafter referred to as the “required spec”) that is required for executing the processing corresponding to that schedule.

Data of the schedule management table 65 is updated at an arbitrary timing when the user registers the schedule. The required spec stored in the required spec column 65E is updated after the processing corresponding to that schedule is executed.

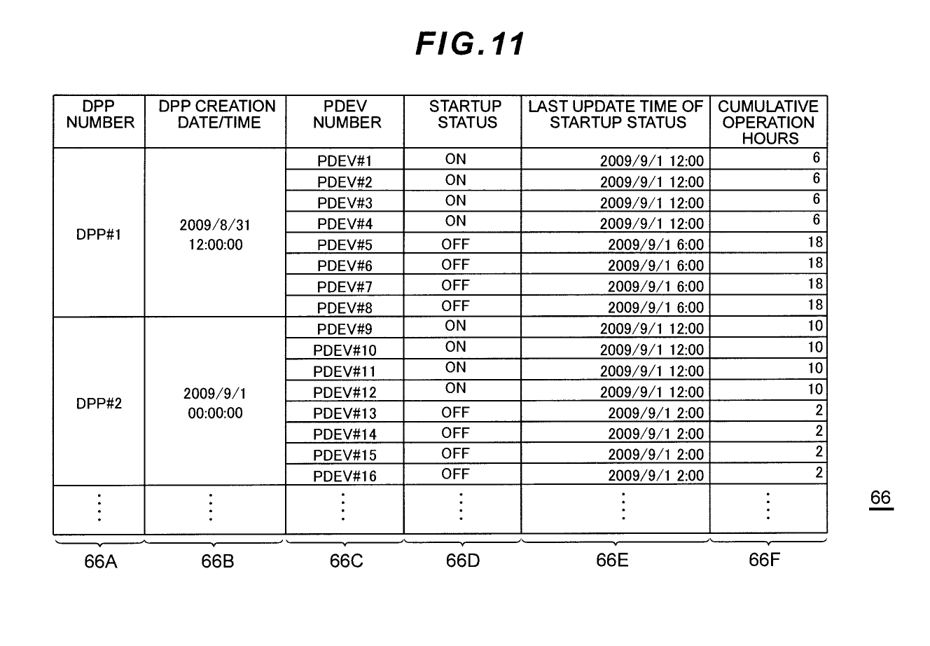

The virtual pool operational information management table 66 is a table that is used for managing the operational status of the physical device PDEV (flash memory module 35) configuring the virtual pool DPP and is configured, as shown in FIG. 11, from a virtual pool number column 66A, a virtual pool creation date/time column 66B, a physical device number column 66C, a startup status column 66D, a startup status last update time column 66E and a cumulative operation hours column 66F.

The virtual pool number column 66A stores the identification number (virtual pool number) of the virtual pool DPP defined in the storage apparatus 4, and the virtual pool creation date/time column 66B stores the creation date/time of the corresponding virtual pool DPP. The physical device number column 66C stores the physical device number of all physical devices PDEV configuring the corresponding virtual pool DPP, and the startup status column 66D stores the current startup status of the corresponding physical device PDEV.

The startup status last update time column 66E stores the time that the startup status of the corresponding physical device PDEV was last confirmed, and the cumulative operation hours column 66F stores the cumulative operation hours of the corresponding physical device PDEV.

Accordingly, the case of the example shown in FIG. 11 shows that the virtual pool DPP indicated as “DPP #1” was created on “2009/8/31 12:00:00,” and is currently configured from the eight physical devices PDEV (flash memory modules 35) of “PDEV#1” to “PDEV#8.” In addition, the example shows that, among the eight physical devices PDEV, the four physical devices PDEV of “PDEV#1” to “PDEV#8” are currently active, the last confirmation time of the startup status of these physical devices PDEV is “2009/9/1 12:00” in all cases, and the cumulative operation hours are “6” hours in all cases.

### (3) Processing of Management Server

The processing contents of the various types of processing to be executed in the management server 3 in relation to the foregoing data placement destination management function, schedule processing function and virtual pool operational status reporting function are now explained. Although the processing subject of the various types of processing is explained as a “program” in the ensuing explanation, it goes without saying that, in reality, the CPU 20 of the management server 3 executes the processing based on such program.

(3-1) Processing Concerning Data Placement Destination Management Function

(3-1-1) Logical Device Information Collection Processing

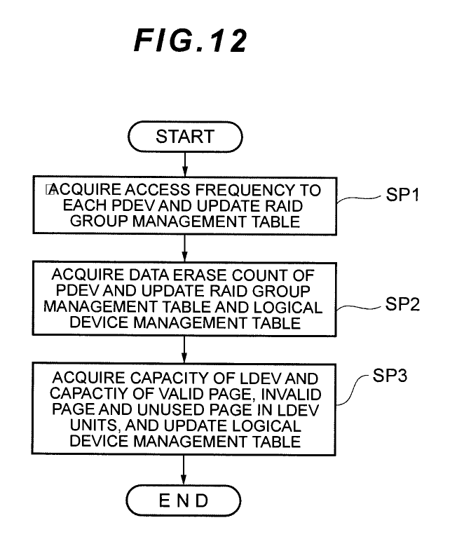

FIG. 12 shows the processing routine of the logical device information update processing to be executed periodically (for instance, every hour) by the data placement destination management program 60 (FIG. 7). The data placement destination management program 60 updates the information concerning the respective logical devices LDEV registered in the RAID group management table 63 (FIG. 8) and the logical device management table 64 (FIG. 9) by periodically executing the logical device information update processing shown in FIG. 12.

Specifically, when the data placement destination management program 60 starts the logical device information update processing, it foremost acquires the access frequency (access count per unit time) to the respective flash memory modules 35 that are being managed in the storage apparatus 4 from the storage apparatus 4 via a prescribed management program not shown, and updates the IOPS column 63F of the RAID group management table 63 based on the acquired information (SP1).

Subsequently, the data placement destination management program 60 acquires the data erase count of the respective flash memory modules 35 that are being managed in the storage apparatus 4 from the storage apparatus 4, and respectively updates the average data erase count column 63D of the RAID group management table 63 and the data erase count column 64G of the logical device management table 64 based on the acquired information (SP2).

Subsequently, the data placement destination management program 60 acquires the capacity of the respective logical devices LDEV and the respective capacities of the current used page, invalid page and unused page of the foregoing logical devices LDEV in logical device LDEV units, and respectively updates the RAID group management table 63 and the logical device management table 64 based on the acquired information (SP3).

The data placement destination management program 60 thereafter ends the logical device information update processing.

(3-1-2) Data Placement Destination Management Processing

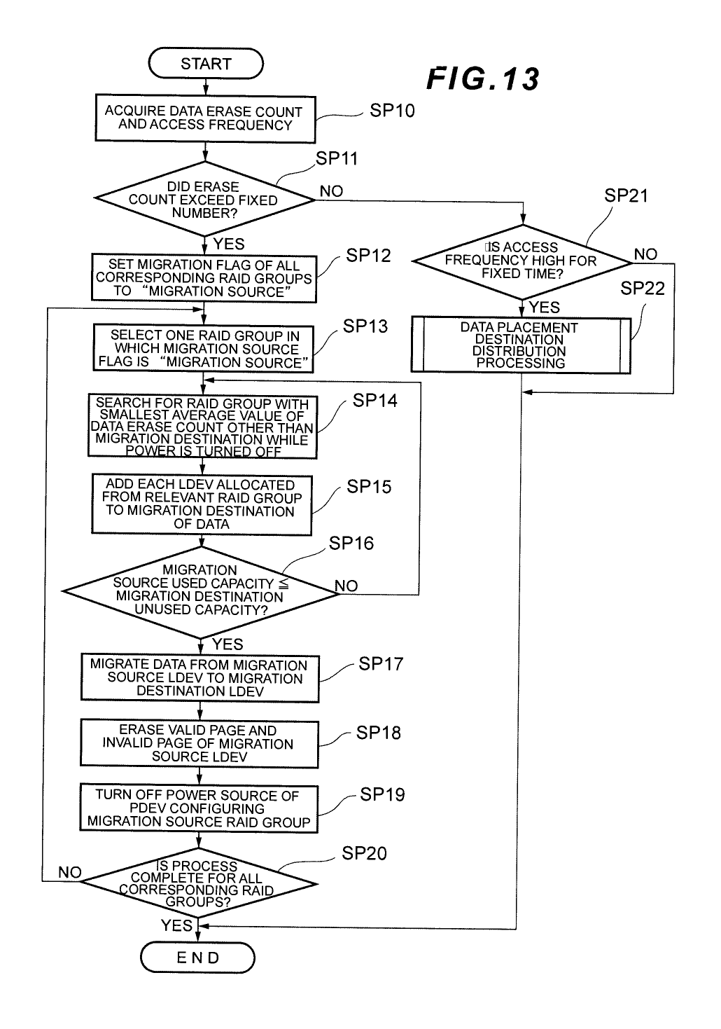

Meanwhile, FIG. 13 shows the processing routine of the data placement destination management processing to be executed periodically (for instance, every hour) by the data placement destination management program 60 of the management server 3. The data placement destination management program 60 centralizes the data that is distributed to a plurality of logical devices LDEV to certain logical devices LDEV, or distributes data that is centralized in certain logical devices LDEV to a plurality of logical devices LDEV according to the processing routine shown in FIG. 13.

Specifically, when the data placement destination management program 60 starts the data placement destination management processing, it foremost acquires the data erase count of each RAID group RG from the logical device management table 64, and acquires the access count per unit time of each RAID group RG from the RAID group management table 63 (SP10).

Subsequently, the data placement destination management program 60 determines whether there is any RAID group RG in which the data erase count exceeds a threshold (this is hereinafter referred to as the “data erase count threshold”) (SP11). The data erase count threshold SH is a value that is calculated based on the following formula when the data erasable count of the block 43 (FIG. 2) (erasable count per block 43 stored in the erasable count column 63E of the RAID group management table 63) that is guaranteed by the respective flash memory chips 40 (FIG. 2) in the flash memory module 35 is D, and the weighing variable is i:

[Formula 1]

SH=D×i/10 (1)

The weighing variable i is incremented (increased by one) when the data erase count of all flash memory modules 35 configuring the relevant RAID group RG exceeds Formula (1) for each RAID group RG.

If the data placement destination management program 60 obtains a positive result in the determination at step SP11, it sets the respective logical devices LDEV allocated from the respective RAID groups RG in which the data erase count exceeds the data erase count threshold SH as logical devices (these are hereinafter referred to as the “migration source logical devices”) LDEV to become the migration source of data in the data placement destination centralization processing described later with reference to step SP13 to step SP20 (SP12). Specifically, the data placement destination management program 60 sets the migration flag stored in the migration flag column 63H (FIG. 8) corresponding to the RAID groups RG in the RAID group management table 63 to “migration source.”

Subsequently, the data placement destination management program 60 selects one RAID group RG among the RAID groups RG in which the migration flag was set to “migration source” at step SP12 (SP13).

Subsequently, the data placement destination management program 60 refers to the RAID group management table 63, and searches for a RAID group with the smallest average value of the data erase count among the RAID groups RG in which the power status is “ON” and the migration flag is “Not Set” (SP14).

Then, the data placement destination management program 60 determines the respective logical devices LDEV allocated from the RAID group RG that was detected in the foregoing search as the logical devices (these are hereinafter referred to as the “migration destination logical devices”) LDEV to become the migration destination of data in the data placement destination centralization processing (SP15). Specifically, the data placement destination management program 60 sets the migration flag of the migration flag column 63H corresponding to the RAID group RG in the RAID group management table 63 to “migration destination.”

Subsequently, the data placement destination management program 60 determines whether the total used capacity of the migration source logical devices LDEV is less than the total unused capacity of the migration destination logical devices LDEV (SP16). Specifically, the data placement destination management program 60 refers to the logical device management table 64 and calculates the total capacity of the valid pages of all migration source logical devices LDEV as the total used capacity of the migration source logical devices LDEV. The data placement destination management program 60 calculates the total capacity of the invalid pages and unused pages of all migration destination logical devices LDEV as the total unused capacity of the migration destination logical devices LDEV. The data placement destination management program 60 thereafter compares the total used capacity of the migration source logical devices LDEV and the total unused capacity of the migration destination logical devices LDEV that were obtained as described above, and determines whether the total used capacity of the migration source logical devices LDEV is less than the total unused capacity of the migration destination logical devices LDEV.

If the data placement destination management program 60 obtains a negative result in this determination, it returns to step SP14, and thereafter adds the migration destination logical device LDEV in RAID group RG units by repeating the processing of step SP14 to step SP16.

When the data placement destination management program 60 eventually obtains a positive result at step SP16 as a result of the total unused capacity of the migration destination logical devices LDEV becoming greater than the total used capacity of the migration source logical devices LDEV, it controls the CPU 31 (FIG. 1) of the storage apparatus 4 so as to migrate the data stored in the migration source logical device LDEV to the migration destination logical device LDEV (SP17).

Subsequently, the data placement destination management program 60 controls the CPU 31 (FIG. 1) of the storage apparatus 4 in order to erase the data stored respectively in the valid pages and invalid pages of the respective migration source logical devices LDEV, and updates the logical device management table 64 to the latest condition accordingly (SP18).

In addition, the data placement destination management program 60 stops the power supply to all flash memory modules 35 configuring the RAID group RG selected at step SP13, and updates the power status of that RAID group RG in the RAID group management table 63 to “OFF” (SP19).

Subsequently, the data placement destination management program 60 determines whether the foregoing processing of step SP13 to step SP19 has been performed to all RAID groups RG in which the migration flag was set to “migration source” at step SP13 (SP20). If the data placement destination management program 60 obtains a negative result in this determination, it returns to step SP13, and thereafter repeats the processing of step SP13 to step SP20 until obtaining a positive result at step SP20 while sequentially selecting a different RAID group RG at step SP13.

When the data placement destination management program 60 eventually obtains a positive result at step SP20 as a result of completing the processing of step SP13 to step SP19 regarding all RAID groups RG in which the migration flag was set to “migration source” at step SP13, it ends the data placement destination management processing.

Meanwhile, if the data placement destination management program 60 obtains a negative result in the determination at step SP11, it determines whether there is a RAID group RG in which the access frequency is high for a fixed time (SP21). If the data placement destination management program 60 obtains a negative result in this determination, it ends the data placement destination management processing.

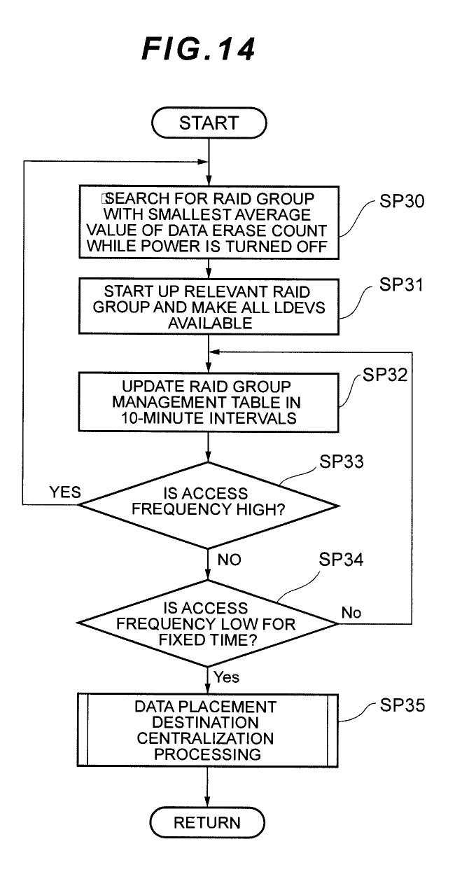

Meanwhile, if the data placement destination management program 60 obtains a positive result in the determination at step SP21, it executes the data placement destination distribution processing described later with reference to FIG. 14 (SP22), and thereafter ends the data placement destination management processing.

(3-1-3) Data Placement Destination Distribution Processing

FIG. 14 shows the processing routine of the data placement destination distribution processing to be executed by the data placement destination management program 60 at step SP22 of the foregoing data placement destination management processing (FIG. 13). The data placement destination management program 60 distributes the data that is centralized in certain logical devices LDEV to a plurality of logical devices LDEV according to the processing routine shown in FIG. 14.

Specifically, when the data placement destination management program 60 proceeds to step SP22 of the data placement destination management processing, it starts the data placement destination distribution processing and foremost refers to the RAID group management table 63, and searches for the RAID group RG with the smallest average value of the data erase count among the RAID groups RG in which the power status is “OFF” and the migration flag is “Not Set” (SP30).

Subsequently, the data placement destination management program 60 starts supplying power to all flash memory modules 35 configuring the RAID group RG that was detected in the foregoing search, and thereby makes available all logical devices LDEV which were allocated from that RAID group RG (SP31).

Consequently, data that is newly written from the business host 2 into the virtual volume DP-VOL (FIG. 4) will thereafter be distributed and stored in all available logical devices LDEV including the logical devices LDEV which were made available at step SP31.

Subsequently, the data placement destination management program 60 updates the RAID group management table 63 and the logical device management table 64 by executing the logical device information collection processing explained above with reference to FIG. 12 (SP32). The logical device information collection processing at step SP32, for instance, is processing that is performed in 10-minute intervals, and is omitted if 10 minutes have not lapsed after the execution of the previous logical device information collection processing.

The data placement destination management program 60 thereafter refers to the RAID group management table 63, and determines whether the I/O access frequency to any RAID group RG is high (SP33).

Specifically, the data placement destination management program 60 determines that the I/O access frequency to a RAID group RG is high if the status resulting from the following Formula continues for a fixed time, when the total I/O access count per unit time of the respective logical devices LDEV allocated from that RAID group RG stored in the IOPS column of the RAID group management table 63 is X, the processing performed per unit time of the corresponding flash memory module 35 stored in the processing performance column 63G of the RAID group management table 63 is Y, and the parameter for determining whether the I/O access frequency is high (this is hereinafter referred to as the “excessive access determination parameter”) is 0.7:

[Formula 2]

X≧0.7×Y (2)

Thus, the data placement destination management program 60 determines whether Formula (2) is satisfied for each RAID group RG at step SP33. The value of the excessive access determination parameter is an updatable value, and is not limited to 0.7.

If the data placement destination management program 60 determines that any one of the RAID groups RG still satisfies Formula (2) (that is, if it determines that there is still a RAID group RG that is subject to excessive access), it returns to step SP30, and thereafter repeats the processing of step SP30 onward. Consequently, the RAID groups RG to which the power supply was stopped will be sequentially started up, and the logical devices LDEV allocated from such RAID groups RG will sequentially become available.

Meanwhile, if the data placement destination management program 60 obtains a negative result in the determination at step SP33, it refers to the RAID group management table 63, and determines whether the I/O access frequency to any RAID group RG is low (SP34).

Specifically, the data placement destination management program 60 determines that the I/O access frequency to a RAID group RG is low if the status resulting from the following Formula continues for a fixed time, when parameter for determining whether the I/O access frequency is low (this is hereinafter referred to as the “low access determination parameter”) is 0.4:

[Formula 3]

X≦0.4×Y (3)

The value of the low access determination parameter is an updatable value, and is not limited to 0.4.

If the data placement destination management program 60 determines that none of the RAID groups RG satisfy Formula (3) (that is, it determines that there is no RAID group RG with a low access frequency), it returns to step SP32, and thereafter repeats the processing of step SP32 onward.

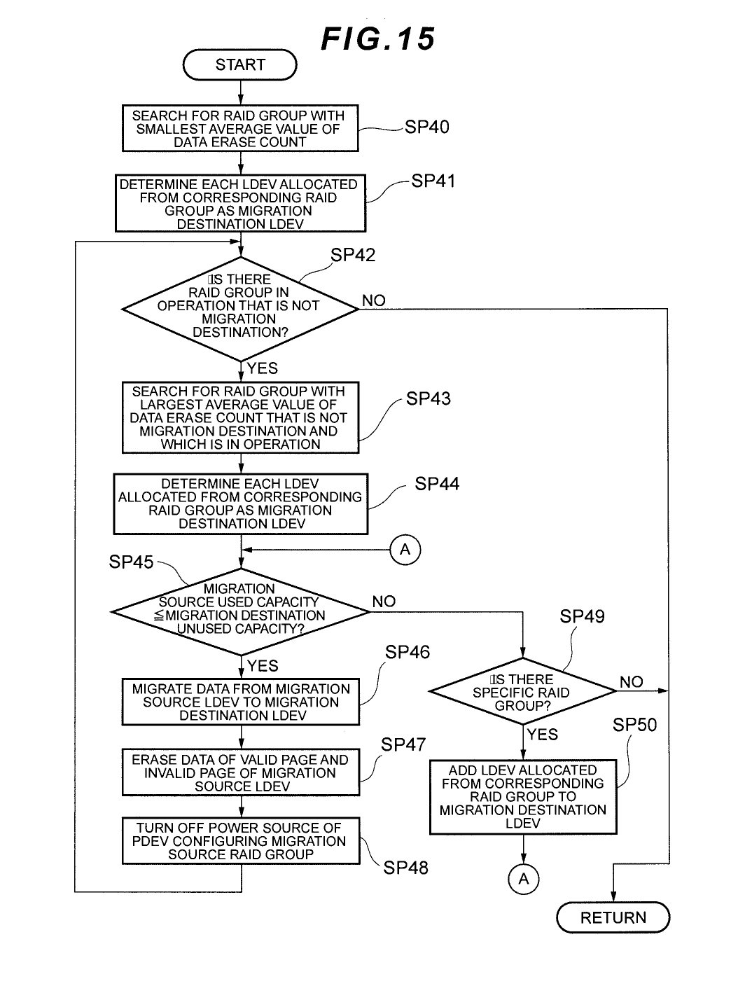

Meanwhile, if the data placement destination management program 60 obtains a positive result in the determination at step SP34, it executes the data placement destination centralization processing described later with reference to FIG. 15 (SP35), and thereafter returns to the data placement destination management processing explained above with reference to FIG. 13.

(3-1-4) Data Placement Destination Centralization Processing

FIG. 15 shows the processing routine of the data placement destination centralization processing to be executed by the data placement destination management program 60 at step SP35 of the data placement destination distribution processing. The data placement destination management program 60 centralizes the data that was distributed to a plurality of logical devices LDEV to certain logical devices LDEV according to the processing routine shown in FIG. 15.

Specifically, when the data placement destination management program 60 proceeds to step SP35 of the data placement destination distribution processing explained above with reference to FIG. 14, it starts the data placement destination centralization processing and foremost refers to the RAID group management table 63, and searches for the RAID group RG with the smallest average value of the data erase count (SP40).

Subsequently, when the data placement destination management program 60 detects the RAID group RG that satisfies the foregoing condition as a result of the search, it determines the respective logical devices LDEV allocated from that RAID group RG to be the migration destination logical devices (SP41). Specifically, the data placement destination management program 60 sets the migration flag stored in the migration flag column 63H (FIG. 8) corresponding to the foregoing logical devices LDEV in the RAID group management table 63 to “migration destination” (SP41).

Subsequently, the data placement destination management program 60 refers to the RAID group management table 63, and determines whether there is any active RAID group RG other than the RAID group RG that was detected in the search at step SP40 (SP42). Specifically, a step SP42, the data placement destination management program 60 searches for a RAID group RG in which the migration flag stored in the corresponding migration flag column 63H of the RAID group management table 63 is “Not Set,” and the power status stored in the corresponding power status column 63I of the RAID group management table 63 is “ON.”

If the data placement destination management program 60 obtains a negative result in this determination, it updates all migration flags stored in the respective migration flag columns 63H of the RAID group management table 63 to “Not Set,” and thereafter returns to the data placement destination distribution processing explained above with reference to FIG. 14.

Meanwhile, if the data placement destination management program 60 obtains a positive result in the determination at step SP42, it searches for an active RAID group RG other than the RAIG group RG that was detected in the search at step SP40 and which is a RAID group RG with the largest data erase count (SP43). Specifically, at step SP43, the data placement destination management program 60 searches for the RAID group with the largest average value of the data erase count among the RAID groups RG in which the migration flag stored in the corresponding migration flag column 63H of the RAID group management table 63 is “Not Set,” and the power status stored in the corresponding power status column 63I of the RAID group management table 63 is “ON.”

Then, the data placement destination management program 60 sets the respective logical devices LDEV allocated from the RAID group RG that was detected in the foregoing search as the migration source logical devices (SP44). Specifically, the data placement destination management program 60 sets the migration flag stored in the migration flag column 63H corresponding to that RAID group RG in the RAID group management table 63 to “migration source.”

Subsequently, based on the same method as the method described above with reference to step SP16 of the data placement destination management processing (FIG. 13), the data placement destination management program 60 determines whether the total used capacity of the migration source logical devices LDEV is less than the total unused capacity of the migration destination logical devices LDEV (SP45).

If the data placement destination management program 60 obtains a negative result in this determination, it refers to the RAID group management table 63, and determines whether there is an active RAID group RG in which the logical devices LDEV allocated from that RAID group RG are not set as the migration destination logical devices and which has the smallest average value of the data erase count (SP49). Specifically, at step SP49, the data placement destination management program 60 determines whether there is a RAID group RG with the smallest average value of the data erase count among the RAID groups RG in which the migration flag stored in the corresponding migration flag column 63H of the RAID group management table 63 is “Not Set” and the power status stored in the corresponding power status column 63I of the RAID group management table 63 is “ON.”

If the data placement destination management program 60 obtains a negative result in this determination, it updates all migration flags stored in the respective migration flag columns 63H of the RAID group management table 63 to “Not Set,” and thereafter returns to the data placement destination distribution processing explained above with reference to FIG. 14.

Meanwhile, if the data placement destination management program 60 obtains a positive result in the determination at step SP45, it adds the respective logical volumes LDEV allocated from the RAID group RG in which the existence thereof was confirmed at step SP42 to the migration destination logical devices (SP50). Specifically, the data placement destination management program 60 sets the migration flag stored in the migration flag column 63H corresponding to that RAID group RG in the RAID group management table 63 to “migration destination.”

Subsequently, the data placement destination management program 60 returns to step SP45, and thereafter repeats the loop of step SP45-step SP49-step SP50-step SP45 until the total used capacity of the migration source logical devices LDEV becomes less than the total unused capacity of the migration destination logical devices LDEV.

When the data placement destination management program 60 eventually obtains a positive result in the determination at step SP45, it controls the CPU 31 (FIG. 1) of the storage apparatus 4 so as to migrate the data stored in the migration source logical devices LDEV to the migration destination logical devices LDEV (SP46).

Subsequently, the data placement destination management program 60 controls the CPU 31 of the storage apparatus 4 so as to erase the data stored respectively in the valid pages and invalid pages of the respective migration source logical devices LDEV, and thereafter updates the logical device management table 64 to the latest condition accordingly (SP47).

Subsequently, the data placement destination management program 60 stops the power supply to all flash memory modules 35 configuring the RAID group RG detected in the search at step SP43, and additionally updates the power status stored in the power status column 63I corresponding to that RAID group RG in the RAID group management table 63 to “OFF” (SP48).

Moreover, the data placement destination management program 60 thereafter returns to step SP42, and repeats the processing of step SP42 onward until it obtains a negative result at step SP42 or step SP49. When the data placement destination management program 60 eventually obtains a negative result at step SP42 or step SP49, it returns to the data placement destination distribution processing (FIG. 14).

(3-2) Processing Concerning Schedule Processing Function

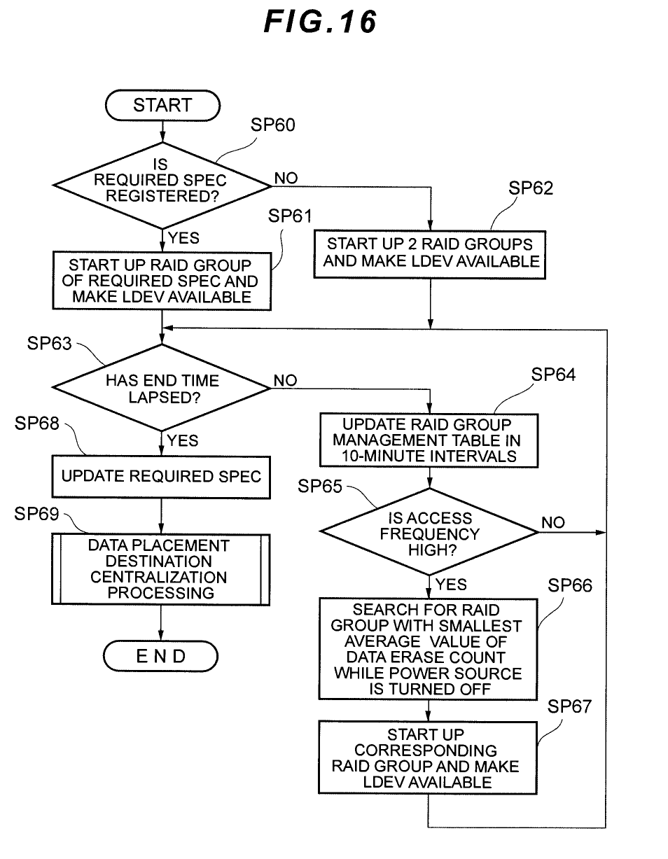

Meanwhile, FIG. 16 shows the processing routine of the schedule processing to be executed by the schedule management program 61 (FIG. 7) concurrently with the various types of processing described above with reference to FIG. 12 to FIG. 15. The schedule processing is processing for distributing data to a plurality of logical devices LDEV from the start time to the end time of the schedule set by the user as explained above, and centralizing the data to certain logical devices LDEV once again after the lapse of the end time. Thus, the start time and end time of the schedule are set to coincide with the period in which the increase in access is known in advance.

The schedule management program 61 is constantly monitoring the schedule management table 65 (FIG. 10), starts the schedule processing one minute before the start time of any schedule registered in the schedule management table 65, and foremost determines the required spec is registered in the required spec column 65E (FIG. 10) corresponding to the schedule to be executed in the schedule management table 65 (SP60).

If the schedule management program 61 obtains a positive result in this determination, it starts up the necessary number of RAID groups RG registered in the required spec column 65E, and makes available the respective logical devices LDEV allocated from such RAID groups RG (SP61).

Specifically, at step SP61, the schedule management program 61 refers to the RAID group management table 63, and selects the required number of RAID groups RG in order from the RAID group RG with the smallest average value of the data erase count stored in the average data erase count column 63D (FIG. 8) among the RAID groups RG in which the power status is “OFF.” Then, the schedule management program 61 starts supplying power to the respective flash memory modules 35 configuring each of the selected RAID groups RG, and updates the power status stored in the power status column 63I corresponding to the RAID groups RG in the RAID group management table 63 to “ON.” The schedule management program 61 thereafter proceeds to step SP63.

Meanwhile, if the schedule management program 61 obtains a negative result in the determination at step SP60, it determines that two RAID groups RG are required for executing the schedule, and starts up two RAID groups RG to make available the logical devices LDEV that were allocated from such RAID groups RG (SP62). The specific processing contents of step SP62 are the same as step SP61, and the explanation thereof is omitted. The schedule management program 61 thereafter proceeds to step SP63.

When the schedule management program 61 proceeds to step SP63, it acquires the current time with a timer not shown, and determines whether the end time of the schedule registered in the schedule management table 65 has lapsed (SP63).

If the schedule management program 61 obtains a negative result in this determination, it updates the RAID group management table 63 by executing the logical device information collection processing explained above with reference to FIG. 12 (SP64). The logical device information collection processing at step SP64 is processing to be performed, for instance, every 10 minutes, and is omitted if 10 minutes have not elapsed after the execution of the previous logical device information collection processing.

Subsequently, as with step SP33 of the data placement destination distribution processing (FIG. 14), the schedule management program 61 determines whether the I/O access frequency to any RAID group RG registered in the RAID group management table 63 is high (SP65).

If the schedule management program 61 obtains a negative result in this determination, it returns to step SP63. Meanwhile, if the schedule management program 61 obtains a positive result in this determination, it refers to the RAID group management table 63 and searches for the RAID group RG with the smallest average value of the data erase count among the RAID groups RG in which the power status is “OFF” and the migration flag is “Not Set” (SP66).

Subsequently, the schedule management program 61 starts supplying power to all flash memory modules 35 configuring the RAID group RG that was detected in the foregoing search, and thereby makes available all logical devices LDEV which were allocated from that RAID group RG (SP67).

Consequently, data that is newly written from the business host 2 into the virtual volume DP-VOL (FIG. 4) will thereafter be distributed and stored in all available logical devices LDEV including the logical devices LDEV which were made available at step SP61 or step SP62.

The schedule management program 61 thereafter returns to step SP63, and repeats the processing of step SP63 to step SP67 until it obtains a positive result at step SP63.

Meanwhile, when the schedule management program 61 eventually obtains a positive result at step SP63 as a result of the end time of the schedule registered in the schedule management table 65 having elapsed, it updates the required spec stored in the required spec column 65E (FIG. 10) corresponding to that schedule in the schedule management table 65 to the number of required RAID groups RG that were used to execute the schedule (SP68).

Subsequently, the schedule management program 61 executes the data placement destination centralization processing explained above with reference to FIG. 15 (SP69). The schedule management program 61 thereby centralizes the data that was distributed to a plurality of logical devices LDEV to certain logical devices LDEV once again based on the processing of step SP60 to step SP67, additionally maximizes the unused RAID groups RG, and starts supplying power to the flash memory modules 35 configuring the RAID groups RG.

The schedule management program 61 thereafter ends the schedule processing.

(3-3) Processing Concerning Virtual Pool Operational Status Reporting Function

(3-3-1) New Virtual Pool Registration Processing

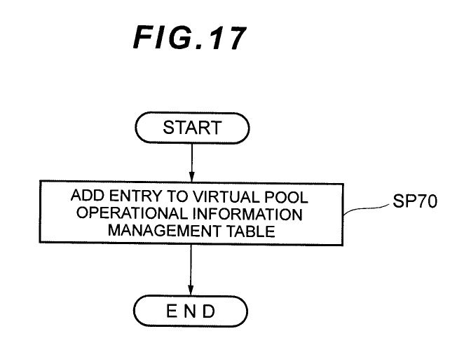

Meanwhile, FIG. 17 shows the processing routine of the new virtual pool registration processing to be executed by the virtual pool operational status report program 62 (FIG. 7) concurrently with the various types of processing explained above with reference to FIG. 12 to FIG. 15.

When a virtual pool DPP is created based on the user's operation, the virtual pool operational status report program 62 starts the new virtual pool registration processing shown in FIG. 17 accordingly, and foremost adds the entries of the newly created virtual pool DPP to the virtual pool operational information management table 66 (FIG. 11) (SP70).

Specifically, the virtual pool operational status report program 62 adds the row corresponding to the created virtual pool DPP to the virtual pool operational information management table 66, and stores the virtual pool number and the creation date/time of the virtual pool DPP in the virtual pool number column 66A (FIG. 11) and the virtual pool creation date/time column 66B of such row, respectively.

In addition, the virtual pool operational status report program 62 stores the flash memory module number of all flash memory modules 35 configuring that virtual pool DPP in the physical device number column 66C (FIG. 11) of that row, and stores “ON” as the current startup status of the corresponding flash memory module 35 in the respective startup status columns 66D (FIG. 11).

Further, the virtual pool operational status report program 62 stores the creation date/time of that virtual pool DPP as the last update time of the startup status of the corresponding flash memory module 35 in the respective startup status last update time columns 66E (FIG. 11) of that row, and stores “0” as the cumulative operation hours of the corresponding flash memory modules 35 in the cumulative operation hours column 66F (FIG. 11).

The virtual pool operational status report program 62 thereafter ends the new virtual pool registration processing.

(3-3-2) Table Update Processing

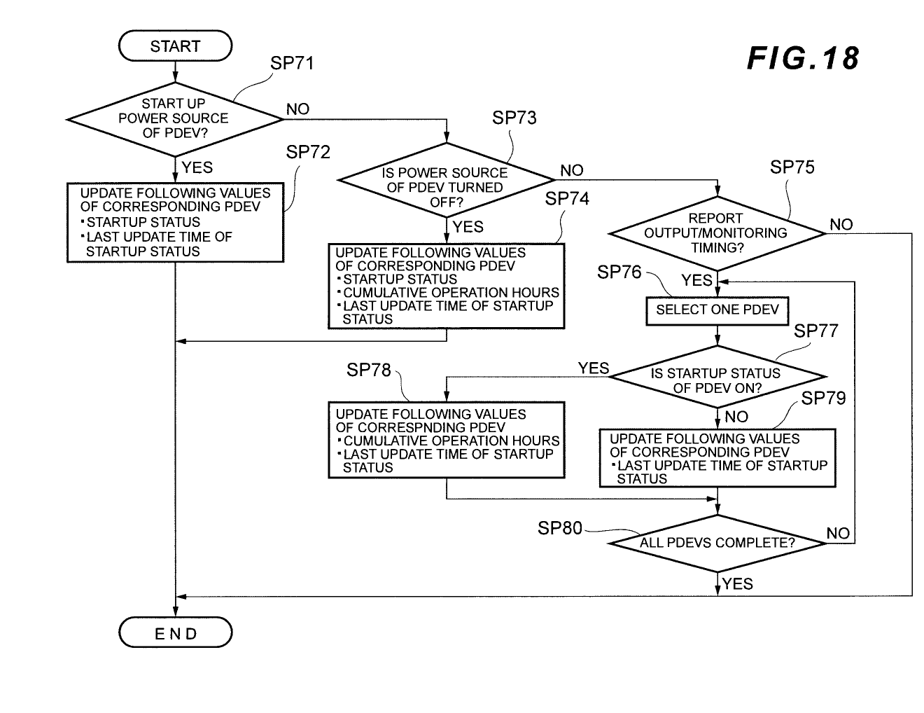

Meanwhile, FIG. 18 shows the processing routine of the table update processing to be executed by the virtual pool operational status report program 62 after the execution of the new virtual pool registration processing. The virtual pool operational status report program 62 updates the virtual pool operational information management table 66 (FIG. 11) according to the processing routine shown in FIG. 18 if the power supply to any flash memory module 35 is started or stopped based on the foregoing data placement destination management processing or the like, or if a command is issued by the user or it becomes a predetermined monitoring timing.

Specifically, the virtual pool operational status report program 62 starts the table update processing if the power supply to any flash memory module 35 is started or stopped, or if a command is issued by the user or it becomes a predetermined monitoring timing, and foremost determines whether the power supply to any flash memory module 35 has been started (SP71).

If the virtual pool operational status report program 62 obtains a positive result in this determination, it updates the startup status stored in the startup status column 66D (FIG. 11) of the entry corresponding to that flash memory module 35 in the virtual pool operational information management table 66 to “ON,” and updates the last update time of the startup status of that flash memory module 35 stored in the startup status last update time column 66E (FIG. 11) to the current time (SP72). The virtual pool operational status report program 62 thereafter ends the table update processing.

Meanwhile, if the virtual pool operational status report program 62 obtains negative result in the determination at step SP71, it determines whether the power supply to any flash memory module 35 has been stopped (SP73).

If the virtual pool operational status report program 62 obtains a positive result in this determination, it updates the startup status stored in the startup status column 66D of the entry corresponding to that flash memory module 35 in the virtual pool operational information management table 66 to “OFF.” In addition, the virtual pool operational status report program 62 updates the last update time of the startup status of that flash memory module 35 stored in the startup status last update time column 66E of the entry corresponding to that flash memory module 35 to the current time, and additionally updates the cumulative operation hours of that flash memory module 35 stored in the cumulative operation hours column 66F (FIG. 11) (SP74). The virtual pool operational status report program 62 thereafter ends the table update processing.

Meanwhile, if the virtual pool operational status report program 62 obtains a negative result in the determination at step SP73, it determines whether the user issued a command for outputting a report or it reached the monitoring timing that was set at fixed intervals (SP75).

If the virtual pool operational status report program 62 obtains a negative result in this determination, it ends the table update processing.

Meanwhile, if the virtual pool operational status report program 62 obtains a positive result in the determination at step SP75, it selects one flash memory module 35 which has not yet been subject to the processing of step SP77 to step SP79 among all flash memory modules 35 registered in the virtual pool operational information management table 66, and determines whether the startup status of that flash memory module 35 is “ON” by referring to the corresponding startup status column 66D of the virtual pool operational information management table 66 (SP77).

If the virtual pool operational status report program 62 obtains a positive result in this determination, it updates the cumulative operation hours stored in the cumulative operation hours column 66F corresponding to that flash memory module 35 in the virtual pool operational information management table 66 to a value that is obtained by adding, to the foregoing cumulative operation hours, the hours from the last update time of the startup status stored in the startup status last update time column 66E to the current time, and additionally updates the last update time of the startup status stored in the startup status last update time column 66E corresponding to that flash memory module 35 in the virtual pool operational information management table 66 to the current time (SP78).

Meanwhile, if the virtual pool operational status report program 62 obtains a negative result in the determination at step SP77, it updates the last update time of the startup status stored in the startup status last update time column 66E corresponding to that flash memory module 35 in the virtual pool operational information management table 66 to the current time (SP79).

Then, the virtual pool operational status report program 62 determines whether the processing of step SP77 to step SP79 has been performed to all flash memory modules 35 registered in the virtual pool operational information management table 66 (SP80). If the virtual pool operational status report program 62 obtains a negative result in this determination, it returns to step SP76, and thereafter repeats the same processing until it obtains a positive result at step SP80.

When the virtual pool operational status report program 62 eventually obtains a positive result at step SP80 as a result of the processing of step SP77 to step SP79 being performed to all flash memory modules 35 registered in the virtual pool operational information management table 66, it ends the table update processing.

(3-3-3) Report Output Processing

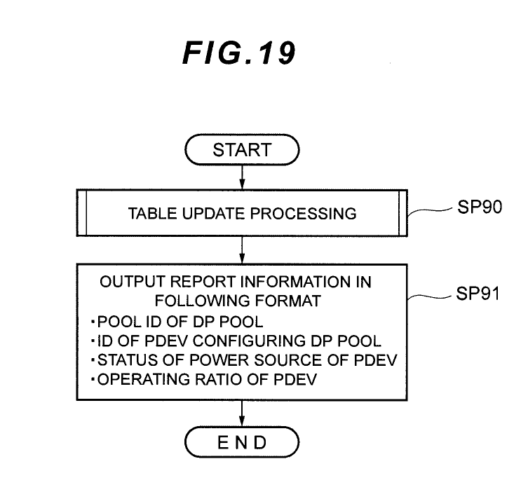

FIG. 19 shows the processing routine of the report output processing to be executed by the virtual pool operational status report program 62 concurrently with the various types of processing explained above with reference to FIG. 12 to FIG. 15. The virtual pool operational status report program 62 outputs a report on the operational status of the virtual pool DPP (FIG. 4) according to the processing routine shown in FIG. 19.

Specifically, the virtual pool operational status report program 62 starts the report output processing shown in FIG. 19 when the user issues a command for outputting a report or when it becomes a timing for outputting a report as set to be periodically executed, and foremost updates the virtual pool operational information management table 66 to the latest condition by executing the table update processing explained above with reference to FIG. 18 (SP90).

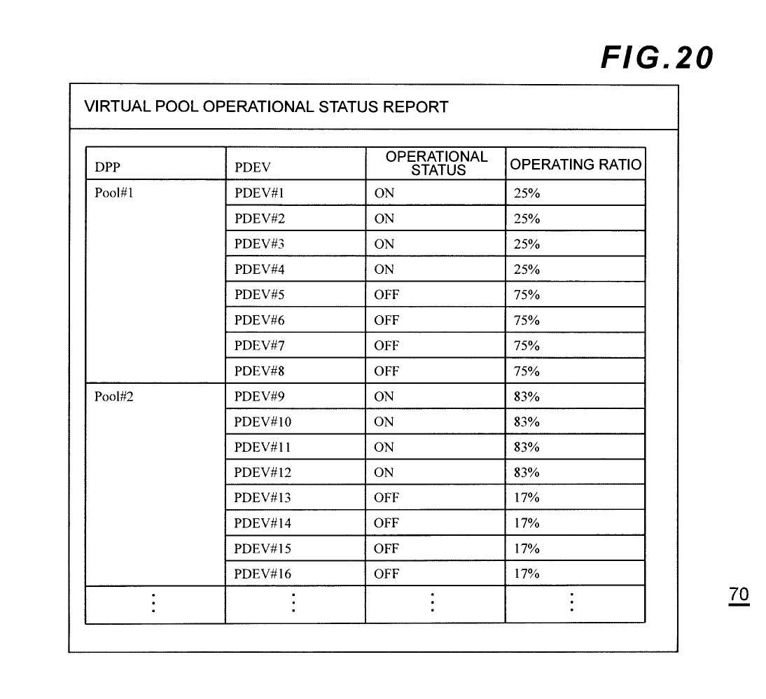

Subsequently, the virtual pool operational status report program 62 refers to the virtual pool operational information management table 66 that was updated at step SP90, and displays, for instance, a report screen 70 as shown in FIG. 20 on the management server 3, or prints the same from a printer not shown that is coupled to the management server 3.

The report screen 70 shows a list regarding the respective virtual pools DPP existing in the storage apparatus 4 including the virtual pool number of that virtual pool, the physical device number of the respective flash memory modules 35 configuring that virtual pool DPP, the operational status of the flash memory modules 35, and the operating ratio of the flash memory modules 35. The operating ratio is a numerical value that is sought based on the following Formula:

[Formula 4]

Operating ratio=Cumulative operation hours/(Current time−Creation date/time of that virtual pool)×100 (4)

The virtual pool operational status report program 62 thereafter ends the report output processing.

### (4) Effect of this Embodiment

As described above, with the storage apparatus 4 according to this embodiment, while the number of unused flash memory modules 35 is maximized by centralizing the data placement destination to certain logical devices LDEV during normal times and stopping the power source of such unused flash memory modules 35 on the one hand, the data rewrite count and access frequency of each of the active logical devices LDEV are monitored so as to migrate data stored in logical devices LDEV with in increased data rewrite count to logical devices LDEV with a low rewrite count, and distributing data stored in logical devices LDEV with excessive access frequency to other logical devices LDEV the data placement destination can be suitably changed. Consequently, the power saving operation of the overall storage apparatus 4 can be performed during normal times while leveling the life of the flash memories 41.

### (5) Other Embodiments

Although the foregoing embodiment explained a case of applying the present invention to a storage apparatus of a computer system configured as shown in the drawings, the present invention is not limited thereto, and can also be broadly applied to computer systems of various configurations.

In addition, although the foregoing embodiment explained a case of employing a flash memory as the nonvolatile memory for providing the storage area to be used for reading and writing data from the business host 2 in the storage apparatus 4, the present invention is not limited thereto, and can also be broadly applied to various nonvolatile memories.

Moreover, although the foregoing embodiment explained a case of calculating the data erase count threshold SH based on Formula (1) described above, the present invention is not limited thereto, and the data erase count threshold SH may also be decided based on various other methods.

Furthermore, although the foregoing embodiment explains a case of determining the I/O access frequency to the RAID group RG to be high if the status resulting from foregoing Formula (2) continues for a fixed time and determining the I/O access frequency to the RAID group RG to be low if the status resulting from foregoing Formula (3) continues for a fixed time, the present invention is not limited thereto, and the foregoing determinations may be made according to other methods.

In addition, although the foregoing embodiment explained a case of monitoring the rewrite count and access frequency of data to active logical devices LDEV after centralizing such data to certain logical devices LDEV, the present invention is not limited thereto, and the embodiment may also be such that either the data rewrite count or access frequency is monitored.

The present invention can be applied to storage apparatuses that use a nonvolatile memory such as a flash memory as its storage medium.

What is claimed is:

1. A computer system, comprising:
a storage apparatus for providing a storage area to be used by a host computer for reading and writing data; and
a management apparatus for managing the storage apparatus,
wherein the storage apparatus includes a plurality of nonvolatile memories for providing the storage area; and
a controller for controlling the reading and writing of data of the host computer from and to the nonvolatile memory,
wherein the controller collectively manages the storage areas provided by each of the plurality of nonvolatile memories as a pool, provides a virtual volume to the host computer, dynamically allocates the storage area from the virtual pool to the virtual volume according to a data write request from the host computer for writing data into the virtual volume, and places the data in the allocated storage area,
wherein the management apparatus controls the storage apparatus so as to centralize the placement destination of data from the host computer to a storage area provided by certain nonvolatile memories and stop the power supply to the nonvolatile memories that are unused,
monitors the data rewrite count and/or access frequency to storage areas provided by the nonvolatile memories that are active, and
controls the storage apparatus so as to migrate data to storage areas with a low data rewrite count provided by the other nonvolatile memories if the rewrite count of data in storage areas provided by certain nonvolatile memories increases, and controls the storage apparatus so as to distribute the data placement destination by starting up the nonvolatile memories to which power supply was stopped if the access frequency to storage areas provided by certain nonvolatile memories becomes excessive.

2. The computer system according to claim 1,
wherein the nonvolatile memory is a flash memory.

3. The computer system according to claim 1,
wherein the management apparatus centralizes the placement destination of data from the host computer to a storage area provided by certain nonvolatile memories so as to maximize the nonvolatile memories that are unused.

4. The computer system according to claim 1,
wherein the management apparatus manages a predetermined schedule,
controls the storage apparatus so as to distribute data to storage areas provided by each of the plurality of nonvolatile memories by starting up the nonvolatile memories to which power supply was stopped during the period from a start time to an end time of a certain schedule, and
if the end time of the schedule elapses, controls the storage apparatus so as to centralize the data placement destination to a storage area provided by certain nonvolatile memories and stop the power supply to the nonvolatile memories that are unused.

5. The computer system according to claim 1,
wherein the management apparatus acquires information concerning the operational status of the virtual pool from the storage apparatus, and
outputs the information as a report according to a command from a user or periodically.

6. A method of controlling a storage apparatus including a plurality of nonvolatile memories for providing a storage area to be used by a host computer for reading and writing data,
wherein the storage apparatus collectively manages the storage areas provided by each of the plurality of nonvolatile memories as a pool, provides a virtual volume to the host computer, dynamically allocates the storage area from the virtual pool to the virtual volume according to a data write request from the host computer for writing data into the virtual volume, and places the data in the allocated storage area, and
wherein the method comprises:
a first step of controlling the storage apparatus so as to centralize the placement destination of data from the host computer to a storage area provided by certain nonvolatile memories and stop the power supply to the nonvolatile memories that are unused;
a second step of monitoring the data rewrite count and/or access frequency to storage areas provided by the nonvolatile memories that are active; and
a third step of controlling the storage apparatus so as to migrate data to storage areas with a low data rewrite count provided by the other nonvolatile memories if the rewrite count of data in storage areas provided by certain nonvolatile memories increases, and controlling the storage apparatus so as to distribute the data placement destination by starting up the nonvolatile memories to which power supply was stopped if the access frequency to storage areas provided by certain nonvolatile memories becomes excessive.

7. The method of controlling a storage apparatus according to claim 6,
wherein the nonvolatile memory is a flash memory.

8. The method of controlling a storage apparatus according to claim 6,
wherein, at the first step, the placement destination of data from the host computer is centralized to a storage area provided by certain nonvolatile memories so as to maximize the nonvolatile memories that are unused.

9. The method of controlling a storage apparatus according to claim 6,
wherein, concurrently with the processing of the first to third steps,
a predetermined schedule is managed,
the storage apparatus is controlled so as to distribute data to storage areas provided by each of the plurality of nonvolatile memories by starting up the nonvolatile memories to which power supply was stopped during the period from a start time to an end time of a certain schedule, and
if the end time of the schedule elapses, the storage apparatus is controlled so as to centralize the data placement destination to a storage area provided by certain nonvolatile memories and stop the power supply to the nonvolatile memories that are unused.

10. The method of controlling a storage apparatus according to claim 6,
wherein, concurrently with the processing of the first to third steps,
information concerning the operational status of the virtual pool is acquired from the storage apparatus, and
the information is output as a report according to a command from a user or periodically.
